(19) United States
(12) Patent Application Publication
(10) Pub. No.: US 2025/0273786 A1
(43) Pub. Date: Aug. 28, 2025

(54) BATTERY PACK

(71) Applicant: TOYOTA JIDOSHA KABUSHIKI KAISHA, Aichi-ken (JP)

(72) Inventors: Masaki MIWA, Nagakute-shi (JP); Kento SHINJI, Okazaki-shi (JP); Keita ITO, Togo-cho (JP)

(21) Appl. No.: 19/062,010

(22) Filed: Feb. 25, 2025

(30) Foreign Application Priority Data
Feb. 28, 2024 (JP) 2024-028805

(51) Int. Cl. H01M 50/204; H01M 50/242; H01M 50/249

(52) U.S. Cl. CPC H01M 50/204; H01M 50/242; H01M 50/249; H01M 2220/20

(57) ABSTRACT

The battery pack comprises: two cell modules arranged side by side in a first direction with an intermediate space therebetween, each of the two cell modules having a longitudinal direction parallel to the first direction and a lateral direction parallel to a second direction; a casing that houses the two cell modules, the casing having a main wall, which is a front wall or a rear wall spaced apart from the two cell modules in the second direction; and a reinforcement having at least a first wall disposed along the main wall, wherein the reinforcement overlaps the intermediate space and a part of each of the two cell modules in a front view.

### CROSS REFERENCE TO RELATED APPLICATION

This application claims priority to Japanese Patent Application No. 2024-028805 filed on Feb. 28, 2024, which is incorporated herein by reference in its entirety including the specification, claims, drawings, and abstract.

### TECHNICAL FIELD

This specification discloses a battery pack mounted on a vehicle.

### BACKGROUND

In recent years, electric vehicles using a motor as one of power sources have been widely used. Such an electric vehicle is equipped with a battery pack for supplying electric power to a motor. A battery pack is generally configured by housing a plurality of cell modules and battery-related devices in a casing. Such a battery pack is disclosed in Patent Document 1.

Here, depending on the shape of the space in which the battery pack is installed, a plurality of cell modules may be arranged in the longitudinal direction of the cell modules. In this case, since the casing of the battery pack has a shape elongated in one direction, the rigidity is likely to decrease. As a result, when the vehicle collides with an obstacle, the casing of the battery pack may deform and collide with the cell module.

Therefore, this specification discloses a battery pack capable of effectively preventing collision between a casing and a cell module.

### CITATION LIST

### Patent Document 1: JP. 2008-234870.A

### SUMMARY

The battery pack disclosed herein comprises: two cell modules arranged side by side in a first direction with an intermediate space therebetween, each of the two cell modules having a longitudinal direction parallel to the first direction and a lateral direction parallel to a second direction; a casing that houses the two cell modules, the casing having a main wall, which is a front wall or a rear wall spaced apart from the two cell modules in the second direction; and a reinforcement having at least a first wall disposed along the main wall, wherein the reinforcement overlaps the intermediate space and a part of each of the two cell modules in a front view.

With this configuration, deformation of the casing around the intermediate space is effectively suppressed, and thus collision between the battery casing and the cell module is effectively prevented.

In this case, the casing may further include a bottom wall and a top wall, and the reinforcement may further include a second wall disposed along the bottom wall or the top wall.

With such a configuration, since the shape of the reinforcement becomes three-dimensional, the rigidity of the reinforcement and thus the rigidity of the battery casing are improved. As a result, collision between the battery case and the cell module is more effectively prevented.

The battery pack may further comprise a fastening bracket that fastens the casing to a vehicle body, a part of which is attached to the main walls, wherein the fastening bracket may overlap the reinforcement in the front view.

When the vehicle collides, stress is likely to concentrate around the fastening bracket. With the above configuration, since the battery casing is reinforced around the fastening bracket, deformation of the battery casing is more effectively prevented. Further, in the above configuration, since the fastening bracket, the main wall, and the first wall overlap each other in the plate thickness direction, the rigidity of the battery casing is further improved.

Each of the plurality of cell modules may comprise: a stacked body in which a plurality of battery cells are stacked; and, an end plate provided at an end portion of the stacked body closer to the intermediate space, wherein the battery pack may further include a protector interposed between the end plate and the first wall to inhibit contact between the plurality of cell modules and the first wall.

With this configuration, when the main wall of the battery casing is deformed toward the cell module, the main wall comes into contact with the protector before the cell module. This contact inhibits further deformation of the main wall, thereby effectively preventing contact between the main wall and the cell module.

In this case, the end plate may have a rib protruding toward the intermediate space, the protector may be attached to the rib, and a center of gravity of the protector may be higher than a center of gravity of the cell module.

With this configuration, when the protector is pressed by the main wall, the cell module rotates in a direction away from the main wall. Accordingly, contact between the cell module and the battery casing is more effectively prevented.

According to the technology disclosed in the present specification, collision between the casing and the cell module is effectively prevented.

### BRIEF DESCRIPTION OF DRAWINGS

Embodiment(s) of the present disclosure will be described based on the following figures, wherein:

FIG. 1 is a perspective view of a battery pack;

FIG. 2 is a diagram showing an arrangement of battery packs in the vehicle;

FIG. 3 is a plan view of the battery pack;

FIG. 4 is a cross-sectional view taken along line A-A of FIG. 3;

FIG. 5 is a cross-sectional view taken along line B-B of FIG. 3; and

FIG. 6 is a cross-sectional view showing another example of the battery pack.

### DESCRIPTION OF EMBODIMENT

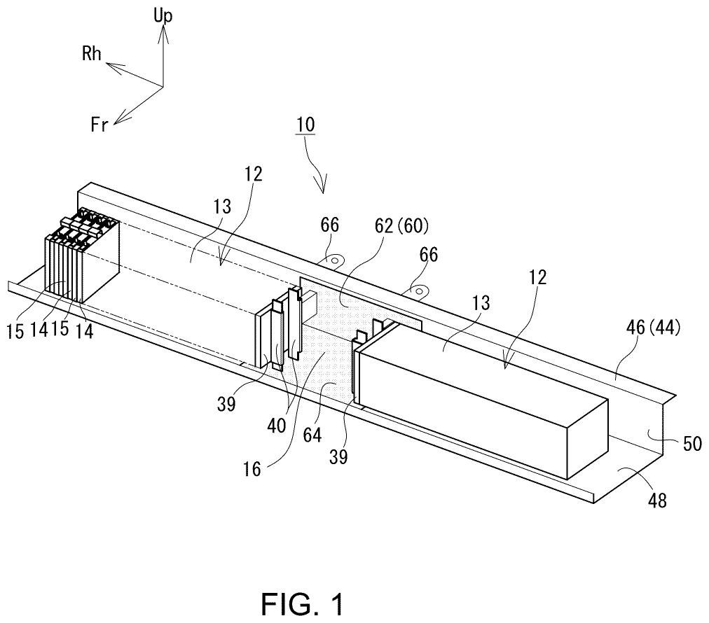

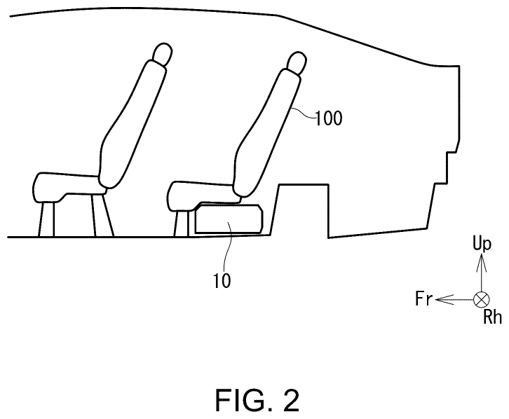

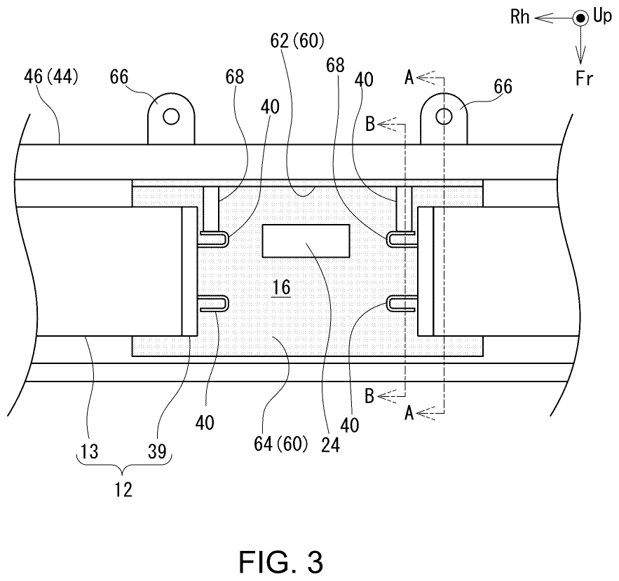

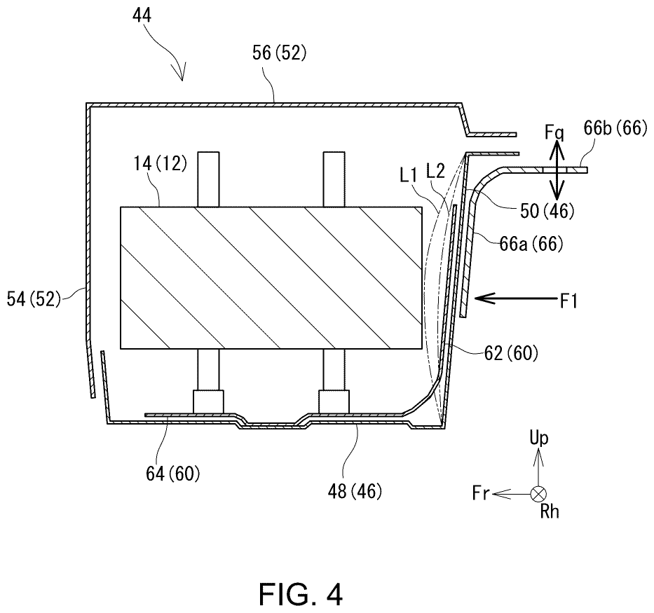

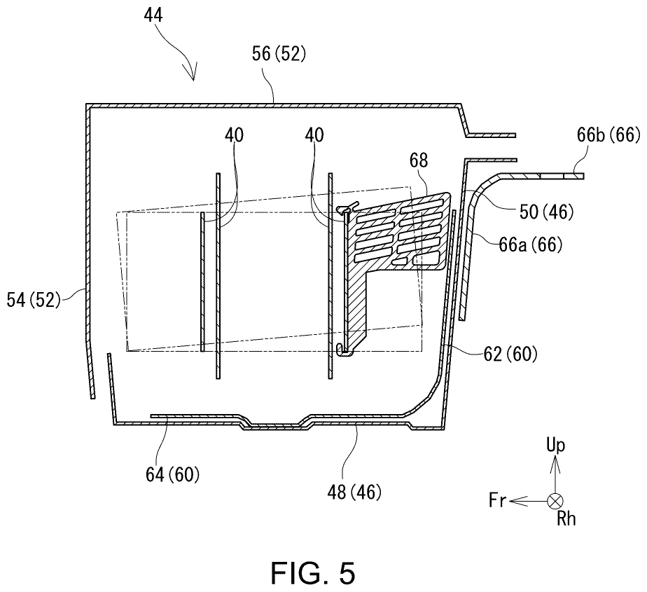

Hereinafter, a configuration of the battery pack 10 will be described with reference to the drawings. FIG. 1 is a schematic perspective view of a battery pack 10. FIG. 2 is a diagram illustrating the position of the battery pack 10 in the vehicle. FIG. 3 is a plan view of the battery pack 10. Further, FIG. 4 is a cross-sectional view taken along line A-A of FIG. 3, and FIG. 5 is a cross-sectional view taken along line B-B of FIG. 3. In the following description, Fr, Up, and Rh indicate a front side, an upper side, and a right side, respectively, as viewed from the user seated on the seat 100. Further, the front, rear, left, and right in the following description mean, in principle, front, rear, left, and right viewed from the user seated on the seat 100. In FIGS. 1 and 3, illustration of the upper casing 52 of the battery casing 44 is omitted.

The battery pack 10 shown in FIG. 1 is mounted on an electric vehicle and supplies electric power to a traveling motor. The electric vehicle is a vehicle having a motor as one of power sources, and is, for example, a hybrid electric vehicle, a battery electric vehicle, a fuel cell electric vehicle, or the like. In this example, as shown in FIG. 2, the battery pack 10 is disposed below the seat 100 (rear seat in the illustrated example). As shown in FIG. 1, in the present example, the longitudinal direction of the cell module 12 is the left-right direction of the seat 100, and is the “first direction” in the claims. The lateral direction of the cell module 12 is the front-rear direction of the seat 100, and is the “second direction” in the claims.

The battery pack 10 includes a plurality of cell modules 12, one or more battery-related devices, and a battery casing 44 (see FIG. 4) that houses them. As shown in FIG. 4, the battery casing 44 includes a lower casing 46, an upper casing 52, and a pair of side panels (not shown). The lower casing 46 has a bottom wall 48 on which the cell module 12 is placed, and a rear wall 50 standing behind the cell module 12. In addition, the upper casing 52 includes a front wall 54 that stands on the front side of the cell module 12, and a top wall 56 that covers the cell module 12 from above. The side panels cover both sides of the battery casing 44 and function as side walls of the battery casing 44. The rear wall 50 and the front wall 54 are located away from the cell module 12 in the front-rear direction (i.e., the lateral direction of the cell module 12), and correspond to the “main wall” in the claims.

The two cell modules 12 are arranged side by side in the left-right direction (that is, the first direction) with an intermediate space 16 therebetween. The cell module 12 includes a stacked body 13 and an end plate 39. The stacked body 13 is configured by alternately stacking a plurality of battery cells 14 and a plurality of separators 15 in the thickness direction. The battery cell 14 is a secondary battery that can be charged and discharged. For example, the battery cell 14 is a lithium ion secondary battery or a sodium ion secondary battery. The battery cell 14 may be an all-solid-state battery. The battery cell 14 is a rectangular battery having a flat rectangular parallelepiped shape. The plurality of battery cells 14 are electrically connected in series or in parallel by conductors called bus bars. The separator 15 is a plate made of an insulating material. Grooves that function as flow paths through which the cooling fluid flows are formed on the surface of the separator 15.

As shown in FIG. 3, an end plate 39 is disposed at one end in the longitudinal direction of the stacked body 13. The end plate 39 is provided with a rib 40 protruding toward the intermediate space 16. For example, as shown in FIG. 3, the rib 40 protrudes from the end plate 39 in a plan view and is bent in a substantially U-shape.

An intermediate space 16 is provided between two adjacent cell modules 12. The battery pack 10 further includes one or more battery-related devices. The battery-related device is a device necessary for safely driving the battery pack 10. For example, a battery controller, a fuse 24 (see FIG. 3), a duct, a junction box, and a service plug correspond to battery-related devices. The battery controller is a computer that controls charging and discharging of the cell module 12, and is generally an electronic device called an ECU (Electronic Control Unit).

The fuse 24 (see FIG. 3) is an electronic component that protects the cell module 12 from overcurrent. The duct is a flow path that allows the cooling flow path and the blower to communicate with the cell module 12. The junction box is an electronic component in which relays for allowing or blocking the flow of power are unitized. The service plug is a component provided at an intermediate point of the power supply circuit, and is a component that cuts off a high voltage by being removed. A part of such battery-related device is disposed in the intermediate space 16, and another part is disposed above the cell module 12. In the present example, the fuse 24 is disposed in the intermediate space 16.

The battery pack 10 is fastened to the vehicle body by the fastening bracket 66. As shown in FIG. 4, the fastening bracket 66 has a first piece 66a extending substantially in the vertical direction and a second piece 66b extending substantially in the horizontal direction from the upper end of the first piece 66a. Therefore, the fastening bracket 66 is a substantially L-shaped metal fitting as a whole. The first piece 66a is attached to the outer surface of the rear wall 50. The second piece 66b is fastened to the vehicle body. As shown in FIG. 3, two fastening brackets 66 are provided at intervals in the longitudinal direction.

The two fastening brackets 66 are attached to the rear wall 50 within the range of the reinforcement 60 in the left-right direction. As a result, the rear wall 50 is sandwiched between the reinforcement 60 and the fastening bracket 66 as shown in FIG. 4.

Here, as is clear from the above description, in the present example, the battery pack 10 is disposed below the seat 100. In general, the space below the seat 100 has a dimension in the front-rear direction smaller than the dimension in the left-right direction. In order to dispose the battery pack 10 in the space below the seat 100, in the present example, the two cell modules 12 are arranged in the left-right direction with the intermediate space 16 interposed therebetween. With this configuration, the size of the battery pack 10 in the front-rear direction can be suppressed to be small. As a result, the battery pack 10 can be efficiently disposed in the space below of the seat 100 elongated in the left-right direction.

Further, in this example, at least a part of the battery-related device is disposed in the intermediate space 16. With this configuration, the number of components disposed on the upper side of the cell module 12 can be reduced, and the vertical dimension of the cell module 12 can be suppressed to be small.

When the cell modules 12 are arranged in the left-right direction, the battery casing 44 is naturally elongated in the left-right direction, and the rigidity decreases. In this case, for example, when a rear-end collision in which an obstacle collides with the vehicle from the rear side occurs and a forward load F1 (see FIG. 4) is input to the rear wall 50, the rear wall 50 may be greatly deformed. When the rear wall 50 comes into contact with the battery cells 14 and the battery-related devices (for example, the fuses 24) disposed in the intermediate space 16 due to the deformation, various problems arise.

Therefore, in the present embodiment, in order to suppress deformation of the battery casing 44, the reinforcement 60 is disposed in the lower casing 46. The reinforcement 60 is a metal panel that reinforces the rear wall 50 and the bottom wall 48 of the lower casing 46. As shown in FIG. 4, the reinforcement 60 has a first wall 62 along the rear wall 50 and a second wall 64 along the bottom wall 48. Therefore, the reinforcement 60 is generally L-shaped as a whole. The reinforcement 60 is disposed inside the lower casing 46 and is joined to the inner surface of the lower casing 46.

As shown in FIG. 3, the left-right direction range of the reinforcement 60 completely overlaps the left-right direction range of the intermediate space 16, and is larger than the left-right direction range of the intermediate space 16. Therefore, in the front view, the reinforcement 60 overlaps with a part of each of the two cell modules 12 and the intermediate space 16. Accordingly, since the rear wall 50 around the intermediate space 16 is reinforced by the reinforcement 60, deformation of the battery casing 44 is suppressed even when a rear collision occurs. As a result, contact of the battery casing 44 with the battery cells 14 and the fuses 24 is effectively suppressed. A line L1 and a line L2 in FIG. 4 are image diagrams of the rear wall 50 when a rear-end collision occurs. A line L1 indicates a case where the reinforcement 60 is not present, and a line L2 indicates a case where the reinforcement 60 is present.

In addition, in the present example, the reinforcement 60 has a substantially L-shape having a first wall 62 along the rear wall 50 and a second wall 64 along the bottom wall 48. By forming the reinforcement 60 not in a flat plate shape but in a three-dimensional shape as described above, the rigidity of the reinforcement 60 itself is improved, and deformation of the battery casing 44 is more effectively prevented.

At the time of the rear collision, a part of the load F1 is transmitted to the rear wall 50 via the fastening bracket 66. Therefore, stress is likely to concentrate on the contact portion between the fastening bracket 66 and the rear wall 50. In this example, as described above, the fastening bracket 66 is attached to the rear wall 50 within the range of the reinforcement 60 in the left-right direction. In other words, the reinforcement 60 reinforces the periphery of the fastening bracket 66 where stress is likely to concentrate. Accordingly, deformation around the fastening bracket 66 is suppressed, and contact between the battery casing 44 and the battery cell 14 is effectively suppressed.

When the vehicle is traveling normally, the vibration Fq (see FIG. 4) of the vehicle body is transmitted to the battery casing 44 via the fastening bracket 66. As described above, in the present example, the periphery of the fastening bracket 66 is reinforced by the reinforcement 60, and the rigidity is high. Therefore, even when the vibration Fq is input, the vibration Fq is attenuated early. As a result, vibration of the rear wall 50 and the bottom wall 48 caused by vibration of the vehicle body is effectively suppressed. Further, the vibration of the cell module 12 accompanying the driving of the cell module 12 is prevented from being transmitted to the vehicle body.

In the present example, an end plate 39 is attached to one end of the cell module 12 in the left-right direction. In this example, the protector 68 is disposed between the end plate 39 and the first wall 62. The protector 68 is a member interposed between the end plate 39 and the first wall 62 to prevent contact therebetween. For example, the protector 68 is a substantially block-shaped member attached to the rib 40 protruding from the end plate 39. The rear end of the protector 68 is closer to the first wall 62 than the rear end of the cell module 12. Therefore, when the first wall 62 and the rear wall 50 are deformed forward, the first wall 62 comes into contact with the protector 68 earlier than the cell module 12. The center of gravity of the protector 68 is higher than the center of gravity of the cell module 12. Therefore, when a forward load is input to the protector 68, the cell module 12 rotates in a direction away from the first wall 62 as indicated by a two-dot chain line in FIG. 5.

By providing such a protector 68, contact between the battery casing 44 and the battery cell 14 can be more effectively prevented. That is, when the rear wall 50 and the first wall 62 are deformed forward due to the rear collision, the first wall 62 comes into contact with the protector 68 before the battery cell 14. This contact suppresses further deformation of the first wall 62 and effectively prevents the first wall 62 from coming into contact with the cell module 12. When the first wall 62 is further greatly deformed and the protector 68 is pushed forward by the first wall 62, the cell module 12 rotates in a direction away from the first wall 62 as indicated by a two-dot chain line in FIG. 5. Accordingly, contact between the cell module 12 and the battery casing 44 is more effectively prevented.

When the load is directly transmitted to the battery cell 14 via the protector 68, the battery cell 14 may be deformed. On the other hand, in the present example, the protector 68 is attached to the end plate 39 (more precisely, the rib 40). As a result, since the load input to the protector 68 is not directly transmitted to the battery cell 14, deformation of the battery cell 14 is effectively prevented.

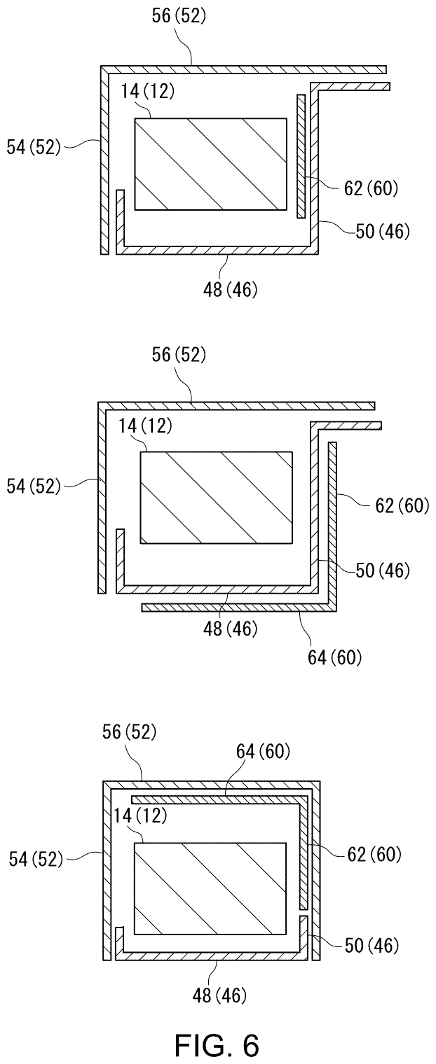

Note that all of the configurations described above are examples, and other configurations may be appropriately changed as long as the configuration described in claim 1 is provided. For example, the reinforcement 60 may have other configurations as long as it is disposed along the front wall 54 or the rear wall 50. For example, the reinforcement 60 may be disposed along the front wall 54 of the battery casing 44. As shown in the upper part of FIG. 6, the reinforcement 60 may have a flat plate shape having only the first wall 62 along the rear wall 50 and the front wall 54. Further, as shown in the middle part of FIG. 6, the reinforcement 60 may be disposed outside the battery casing 44 instead of inside the battery casing 44. Further, the second wall 64 of the reinforcement 60 may be along the top wall 56 of the battery casing 44, as shown in the lower part of FIG. 6.

In the above description, the protector 68 is attached to the end plate 39. However, the protector 68 may be attached to the first wall 62 as long as it is interposed between the end plate 39 and the first wall 62. Further, the protector 68 may be omitted.

In addition, in the above description, the seat 100 is disposed in a posture in which the front side when viewed from the seated person is the vehicle front side. However, the direction of the seat 100 may be changed as appropriate. For example, the seat 100 may be disposed in a posture in which the front side viewed from the seated person is the rear side of the vehicle or the side of the vehicle. In this case, the battery pack 10 may be disposed in a posture in which the longitudinal direction thereof is the left-right direction of the seat 100.

### REFERENCE SIGNS LIST

10 battery pack, 12 cell module, 13 stacked body, 14 battery cell, 15 separator, 16 intermediate space, 24 fuse, 39 end plate, 40 rib, 44 battery casing, 46 lower casing, 48 bottom wall, 50 rear wall, 52 upper casing, 54 front wall, 56 top wall, 60 reinforcement, 62 first wall, 64 second wall, 66 fastening bracket, 66a first piece, 66b second piece, 68 protector, 100 seat.

1. A battery pack mounted on a vehicle, comprising:
two cell modules arranged side by side in a first direction with an intermediate space therebetween, each of the two cell modules having a longitudinal direction parallel to the first direction and a lateral direction parallel to a second direction;
a casing that houses the two cell modules, the casing having a main wall, which is a front wall or a rear wall spaced apart from the two cell modules in the second direction; and
a reinforcement having at least a first wall disposed along the main wall,
wherein the reinforcement overlaps the intermediate space and a part of each of the two cell modules in a front view.

2. The battery pack according to claim 1, wherein
the casing further includes a bottom wall and a top wall, and
the reinforcement further includes a second wall disposed along the bottom wall or the top wall.

3. The battery pack according to claim 1, further comprising a fastening bracket that fastens the casing to a vehicle body, a part of which is attached to the main walls,
wherein the fastening bracket overlaps the reinforcement in the front view.

4. The battery pack according to claim 1, wherein
each of the plurality of cell modules comprises:
a stacked body in which a plurality of battery cells are stacked; and,
an end plate provided at an end portion of the stacked body closer to the intermediate space,
wherein the battery pack further includes a protector interposed between the end plate and the first wall to inhibit contact between the plurality of cell modules and the first wall.

5. The battery pack according to claim 4, wherein
the end plate has a rib protruding toward the intermediate space,
the protector is attached to the rib, and
a center of gravity of the protector is higher than a center of gravity of the cell module.
